(19) United States
(12) Patent Application Publication
(10) Pub. No.: US 2015/0112856 A1
(43) Pub. Date: Apr. 23, 2015

(54) System and Method for Facilitating International Money Transfers

(71) Applicant: Kouros Ershadi, Richmond Hill (CA)

(72) Inventor: Kouros Ershadi, Richmond Hill (CA)

(21) Appl. No.: 14/059,855

(22) Filed: Oct. 22, 2013

(51) Int. Cl. G06Q 20/38

(52) U.S. Cl. CPC G06Q 20/381
USPC 705/39

(57) ABSTRACT

A system for and method for facilitating international money transfers is disclosed. The system includes a database coupled to a web portal wherein potential parties can bid on a monetary exchange between a first and second currency. The system includes a first bank account and a second bank account and a means for transferring the control of funds between parties making deposits in the first and second bank accounts upon the parties agreeing to a transaction. The first and second bank accounts may be in different countries, thereby facilitating an international monetary transaction without the need to move funds between countries.

### FIELD OF THE INVENTION

The invention relates generally to international money transfers and methods and systems therefore.

### BACKGROUND OF THE INVENTION

In today's world there are finite predefined methods to transfer funds between countries. This transfer is provided as a service by major banks and financial institutions. They all have the following commonalities:
1) Exchange rate is defined by the service provider. It is not negotiable and will cause moderate loss in fund transfer transaction for customer.
2) Flat or variable service fees are imposed on every transaction. Multiple redundant fees might be applicable where there is a limit on transaction amount.
3) Small fund transfers are not practical considering the overall transaction costs (rate, fee, etc.).
4) Processing time is enforced by the service providers which might impact customers' urgent needs.
5) No online facilities available for individuals to fulfill such transactions.
6) Unnecessary burden on customers caused by higher complexity in such transactions.
7) Lack of sufficient comparative information (benchmark) on service providers in regards to service reputation, rates, fees and processing time.

Thus, these challenges in the current financial market call for an improved method and system of monetary exchange where customers
a) Seek each other based on their own criteria and money transfer needs
b) Negotiate on their preferred exchange rates
c) Complete the transaction easily and as quickly as possible among them with a few clicks of their mouse in comfort of their home.

### SUMMARY OF THE INVENTION

In accordance with one aspect of the present invention, there is provided a system for facilitating a money transaction or transfer in different currencies between first and second transferors. The system includes a web portal coupled to a database, the database containing a record for each transferor including identification information for the transferors; a target amount and a target currency for a desired money transaction and a paying currency and a desired currency exchange rate for paying for the desired money transaction. The web portal has a display application configured to permit the first and second transferors to post details of the transferor's target amount (i.e. the amount the transferor wishes to transact), target currency (i.e. the currency the transferor wishes to receive), paying currency (i.e. the currency with which the transferor wishes to pay for the transaction) and desired currency exchange rate (i.e. the exchange rate which the transferor desires to pay for the target currency using the paying currency). The display application is further configured to enable each transferor to view details of the target amount, target currency, paying currency and desired exchange rate posted by the other transferor. The web portal has a communication application configured to permit the first and second transferors to communicate with each other through the web portal and negotiate an agreed currency exchange rate for carrying out their respective desired money transfers. The system further includes a first money account and a second money account, the first and second money accounts being in different currencies, the first and second money accounts being coupled to a fulfillment application. The fulfillment application is configured to record a first deposit of first funds into the first account by the first transferor and a second deposit into the second account by the second transferor. The fulfillment application is further configured to record a first and second control codes, the first control code controlling the first funds in the first account and the second control code controlling the second funds in the second account. The fulfillment application is further configured to simultaneously transfer the first control code to the second transferor and the second control code to the first transferor upon the first and second transferors each signaling to the fulfillment application that a transfer agreement has been reached between them on the exchange rate.

In accordance with another aspect of the present invention, there is provided a system for facilitating a money transaction/transfer in different currencies between first and second transferors. The system includes a web portal coupled to a database, the database containing a record for each transferor, the record including identification information for each transferor; a target amount and a target currency for a desired money transaction which the transferor wishes to engage in; and a paying currency and a desired currency exchange rate for paying for the desired money transaction. The web portal also includes a display application configured to permit the first and second transferors to post details of the transferor's target amount, target currency, paying currency and desired currency exchange rate. The display application is further configured to enable each transferor to view details of the target amount, target currency, paying currency and desired exchange rate posted by the other transferor. The web portal also has a communication application configured to permit the first and second transferors to communicate with each other through the web portal and negotiate an agreed currency exchange rate for carrying out their respective desired money transfers. The system further includes a first money account and a second money account, the first and second money accounts being in different currencies. The first and second money accounts are coupled to a fulfillment application, the fulfillment application is configured to record a first deposit of first funds into the first account by the first transferor. The fulfillment application being further configured to record a second deposit into the second account by the second transferor. The fulfillment application is configured to record control of the first and second funds, control being defined as the ability to freely access the first and second funds. The fulfillment application is further configured to simultaneously transfer control of the first and second funds between the first and second transferors upon the first and second transferors each signaling to the fulfillment application that a transfer agreement has been reached between them on the exchange rate.

In accordance with another aspect of the present invention, there is provided a system for facilitating a money transaction in different currencies between first and second parties. The system includes a communication portal coupled to a database, the database containing a first record for the first party. The first record contains identification information for the first party and an identity of a first currency which the first party wishes to trade. The database further includes a second record for the second party, the second record containing identification information for the second party, and an identity of a second currency with which the second party wishes to trade a quantity of the first currency. The system further includes a display application coupled to the communication portal, the display application configured to allow the first party to post the first currency which the first party wishes to trade. The communication portal is configured to permit the first and second parties to communicate with each other and negotiate a trade of a specified amount of the first currency to the second party using the second currency at an agreed to exchange rate. The system further includes a first account in the first currency and a second account in the second currency, the first and second accounts being coupled to a fulfillment application. The fulfillment application is configured to record a first deposit of first funds into the first account by the first party. The fulfillment application is further configured to record a second deposit into the second account by the second party. The fulfillment application is further configured to record control of the first and second funds. The fulfillment application is further configured to simultaneously transfer control of the first and second funds between the first and second parties without transferring the funds between the first and second accounts upon the first and second parties each signaling to the fulfillment application that the agreed to exchange rate was reached.

In accordance with another aspect of the present invention, there is provided a system for facilitating an exchange of first and second currencies between a plurality of parties. The system includes a communication portal coupled to a database, the database containing a record for each party, the record containing identification information for the party and currency information for the currency which said party wishes to trade. The system also includes a display application coupled to the communication portal, the display application configured to allow the parties to post information concerning one of the first and second currencies which said parties wishes to exchange. The communication portal is configured to permit the parties to communicate with each other and negotiate the exchange of the first currency for the second currency. The system further includes a first monetary account in the first currency and a second monetary account in the second currency, the first and second monetary accounts being coupled to a fulfillment application. The fulfillment application is configured to record each deposit of first funds into the first monetary account and each deposit of second funds into the second monetary account. The fulfillment application is further configured to record which party controls the funds corresponding to each deposit of the first and second funds in the first and second monetary accounts. The fulfillment application is further configured to simultaneously transfer control of the funds between the parties without actually transferring the funds upon the parties signaling the communications portal to transfer control.

In accordance with yet another aspect of the present invention, there is provided a system for facilitating a money transfer in different currencies between first and second transferors. The system includes a web portal coupled to a database, the database containing a record for each transferor. Each record includes identification information for the transferor; a target amount and a target currency for a desired money transaction which the transferor wishes to engage in; a paying currency with which the transferor wishes to pay for the transfer, and a desired currency exchange rate which the transferor wishes to pay for the desired money transaction using the paying currency. The web portal has a display application configured to permit the first and second transferors to post details of the transferor's target amount, target currency, paying currency and desired currency exchange rate. The display application is further configured to enable each transferor to view details of the target amount, target currency, paying currency and desired exchange rate posted by the other transferors. The web portal has a communication application configured to permit the first and second transferors to communicate with each other through the web portal and negotiate an agreed currency exchange rate for carrying out their respective desired money transfers. The system further includes a first money account and a second money account, the first and second money accounts being in different countries. The first and second money accounts are coupled to a fulfillment application. The fulfillment application is configured to record a first deposit of first funds into the first account by the first transferor. The fulfillment application being further configured to record a second deposit into the second account by the second transferor. The fulfillment application being further configured to record control of the first and second funds. The fulfillment application being further configured to simultaneously transfer control of the first and second funds between the first and second transferors upon the first and second transferors each signaling to the fulfillment application that a transfer agreement has been reached between them on the exchange rate.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1 is a schematic view of the method of the present invention showing the parties to a monetary exchange between two countries using two different countries.

FIG. 2 is a schematic view of the method of the present invention showing the actual monetary transaction between the parties illustrated in FIG. 1.

FIG. 3 is a schematic over view of the system of the present invention.

FIG. 4 is a schematic more detailed view of the system of the present invention.

In the drawings like characters of reference indicate corresponding parts in the different figures.

### DETAILED DESCRIPTION OF THE INVENTION

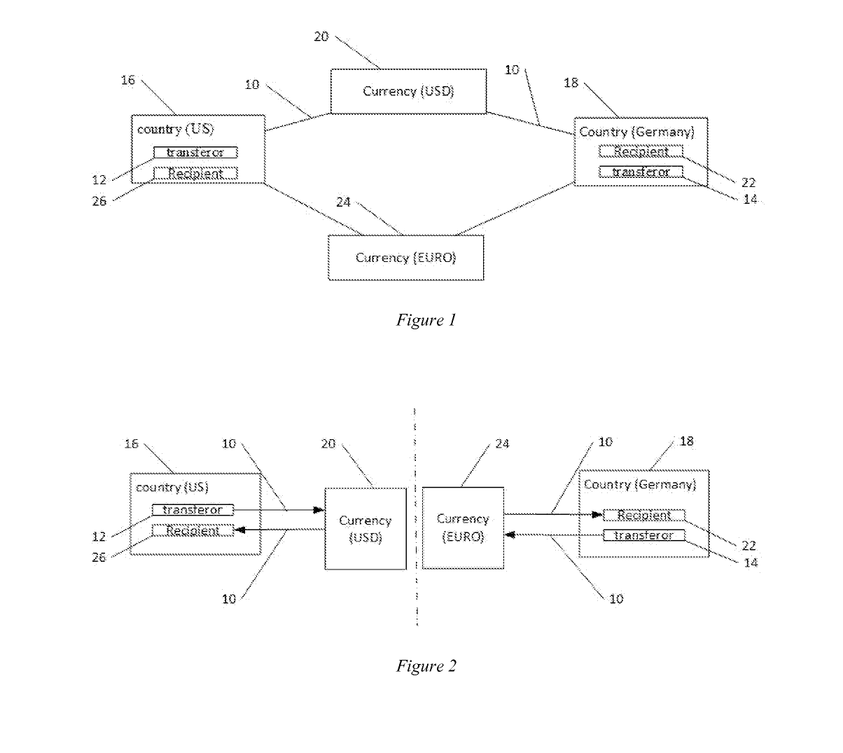

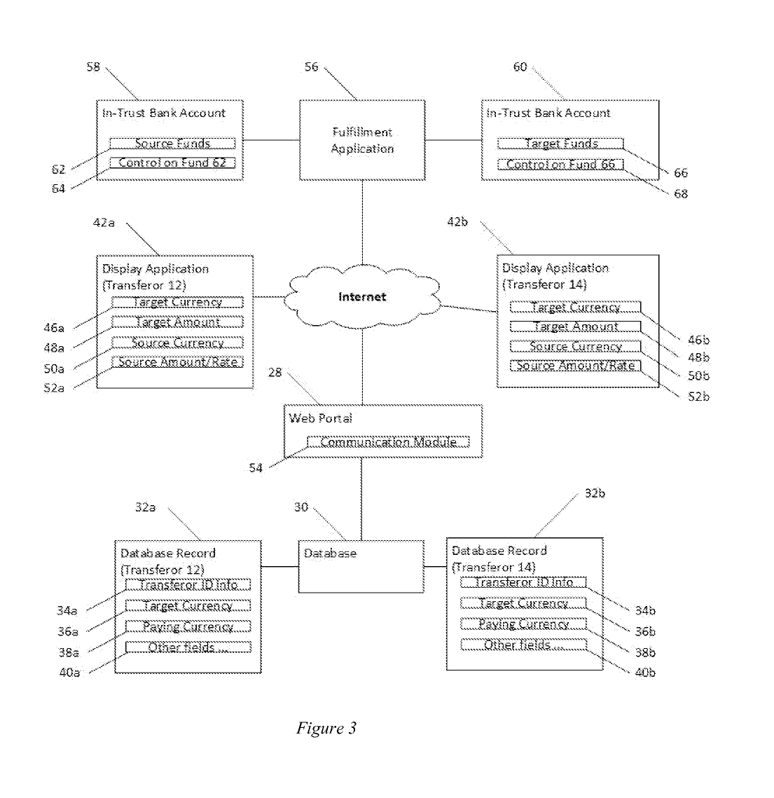

The core invention is the fact that local money transfers replace the international money transfer. This satisfies the needs of both parties located in two different countries. Referring to FIG. 1 we see transferors 12 and 14 located in separate countries 16 and 18. Transferor 12 wishes to send funds to recipient 22, transferor's child, who is located in country 18. Likewise, transferor 14 wishes to send funds to recipient 26, the transferor's child, who is located in country 16. Country 16 (let's say the United States) uses currency 20 (US dollars), while country 18 (let's say Germany) uses currency 24 (Euros). Transferor 12 wishes to send currency 24 (Euros) to recipient 22 while transferor 14 wishes to send currency 20 (US dollars) to recipient 26. Without the system of the present invention, Transferor 12 would have to purchase a quantity of currency 24 from a bank or monetary exchange facility and forward those funds to recipient 22 by means of a cheque, wire transfer or by other means. Transferor, who has access to currency 20, would pay for the quantity of currency 24 using currency 20 at the current exchange rate between the two currency plus whatever transaction fees as may be charged by the institution which transferor purchases currency 24 from. A fee may also have to be paid for transferring the funds from transferor 12 to recipient 22 via an international money transfer. Using the system of the present invention however, transferor 12 can send currency 24 to recipient 22 at a lower cost without the need for an international money transfer.

In the method of the present invention, transferors 12 and 14 can undertake their desired currency transfers by first registering with a web portal 28. Web portal 28 is essentially a website located on a server which is coupled to database 30. Database 30 includes records for both transferors 12 and 14. Record 32a, corresponding to transferor 12, includes a record 34a which contains information identifying transferor 12, such as the transferor's name, address, registration number and the like. Record 36a contains the identity of the currency (target currency) which transferor wishes to purchase, in this case Euros. Record 38a contains the identity of the currency (paying currency) which the transferor wishes to pay for the purchase of the target currency identified in record 36a. Record 38a contains the exchange rate which transferor wishes to exchange US dollars for Euros. Record 38a may be defined as a ratio such as 1.2 US dollars per Euro, or as an actual set amount such as 240 US dollars for 200 Euros. Likewise, record 32b which corresponds to transferor 14, contains fields 34b, 36b, 38b and 40b corresponding to fields 34a, 36a, 38a and 40a, respectively. Web portal 28 is coupled to display applications 42a and 42b via the internet. Display applications 42a and 42b are accessible to transferors 12 and 14, respectively. Display applications 42a and 42b may consist of ordinary web browsers coupled to web portal 28, or they may comprise dedicated applications running on computing devices such as a smart phone. Through web portal 28, transferors 12 and 14 can post details about their respective desired money transfers. Hence, transferor 12 can display the currency he wishes to purchase 46a, the amount of that currency 48a, the currency with which he wishes to pay for the purchase 50a and the desired exchange rate for the transaction 52a. Likewise, transferor 14 can display the currency she wishes to purchase 46b, the amount of that currency 48b, the currency with which she wishes to pay for the purchase 50b and the desired exchange rate for the transaction 52b. Display applications each display information about the identity of each of the transferors, such as the transferors' pseudo name. Web portal 28 is provided with a module 54 permitting transferor 12 to communicate with transferor 14 to negotiate a transfer of funds between them. For example, let us assume that transferor 12 wishes to purchase 200 Euros with US dollars at an exchange rate of 1.1 US dollars per Euro and those are acceptable terms for transferor 14 which wishes to purchase 240 US dollars with Euros at an exchange rate of 1.3 Euros per US dollar. Using web portal 28, transferor 12 and 14 can communicate and agree to an exchange of currencies at an exchange rate of 1.2 US dollars per Euro. Web portal 28 is coupled to fulfillment application 56 which is in turn coupled to bank account 58 and bank account 60. Bank account 58 is a US currency account located in the United States, and bank account 60 is a Euro account located in Germany. As part of the deal agreed to between transferors 12 and 14, transferor 12 deposits funds 62 into account 58, namely 240 US dollars, and fulfillment application 56 records that deposit. Likewise, transferor 14 deposits funds 66 into account 60, namely 200 Euros, and fulfillment application 56 records that deposit. Transferor 12 has control 64 which controls access to funds 62 in account 58. Likewise, transferor 14 has control 68 which controls access to funds 66 in account 60. Fulfillment application 56 record controls 64 and 68. Upon both transferor 12 and 14 signaling to portal 28 that the parties have fulfilled the terms of the agreement and agreed to an exchange rate, web portal 28 signals fulfillment application 58 to simultaneously transfer control 68 to transferor 12 and control 64 to transferor 14. Transferor 12, who now has control 68 can then transfer funds 66 (200 Euros) to recipient 22 and transferor 14 can likewise transfer funds 62 to recipient 26. The net effect is that transferor 12 transfers the sum of 200 Euros to recipient 22 in Germany and transferor 14 transfers the sum of 240 US dollars to recipient 26 in the United States without the need for an actual international money transfer. From the parties' point of view, US dollars and Euros have been exchanged between the United States and Germany without in fact any international money transfer occurring.

The Fulfillment application is preferably a separate an application running on the server which is configured to record and change banking information and records related to the bank accounts coupled to it. The fulfillment application consists of the following components:
1) The Processing Engine. This engine is the fundamental component of the invention which has been implemented using .NET Framework 4.5 (or PHP or any other suitable programming environment). It contains all the necessary business rules and logics behind the core invention to exchange money without crossing geographical borders.
2) The Database Layer. All the relevant database objects for money exchange like Sender ID, Receiver ID, Listing Record, Proof of the funds availability, Exchange Rate, and the like are made available to the Process Engine by Database Layer so the transaction could be accomplished. All other data structures for supported countries including policies, compliance, and controls are defined in this layer as well. SQL Server 2012 is utilized as the technology supporting this layer although any suitable relational database application may be used.
3) Front-end Interface Layer. This layer communicates with Process Engine under strict security controls to grant access permission to the Processing Engine. Internet Information Server 7.2 operating on Windows 2008 R2 is the preferred technology behind this layer.

There are certain standards that have to be followed in development and implementation of this sensitive application core. They are
a) Authentication. The communication channel between the Process Engine and any service consumer must be done under the standard SSL protocol through specific filtered ports. WS-Security which enables message encryption and signature has been implemented in the system.
b) Authorization. The authorization rules defined in the application security portfolio restrict access to the Processing Engine functionalities. These rules are externalized and deployed separate from the core engine and its data.
c) Data Security. All restricted and confidential Client/Transaction data are encrypted at data store. All access privileges are defined in the database to protect the relevant sensitive data.
d) Integration. Currently we are utilizing Standard Soap WebServices protocol to integrate to the core engine. As the need arises additional protocols such as MQ will be added to the infrastructure.

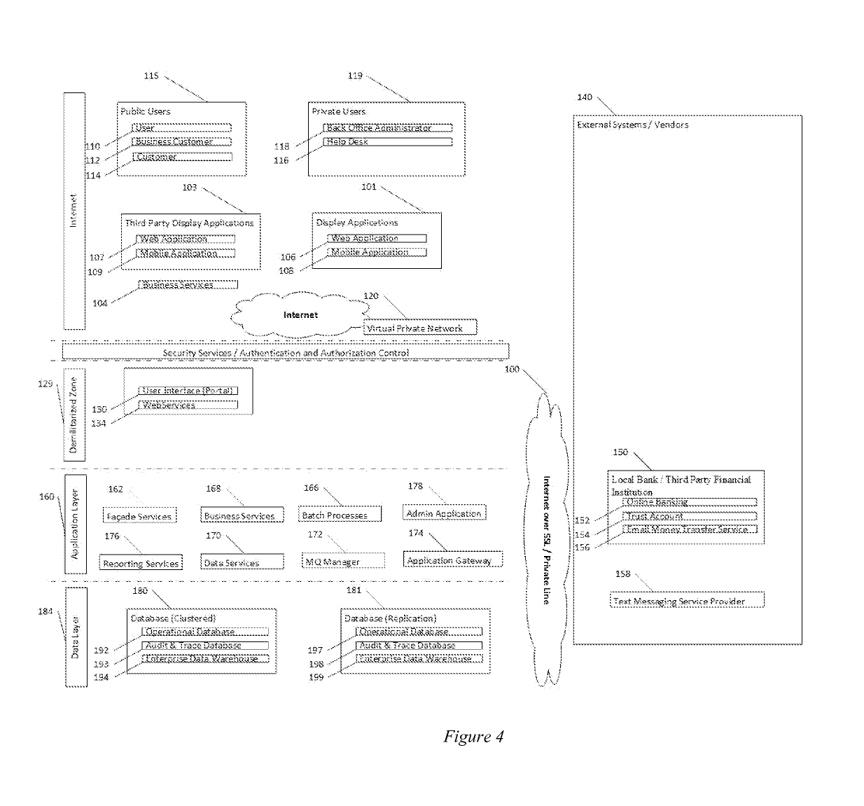

Referring now to FIG. 4, details of the other specific components of the system shall now be discussed. The invention is accessible through multiple channels such as online, agent assisted and Interactive Voice Response (IVR). FIG. 4 is the illustration of the invention's technical solution for internet channel. The term “solution” in this section refers to the internet channel.

This solution supports multiple actors as follows:

### (115) Public Users

(110) Users 110 are potential customers of the solution. They have not registered yet, but they can browse and search the environment and read through the help material or legal terms and policies and any other public content of the solution.
(112) Business Customers 112 are financial or exchange companies who use special features in the solution to be able to serve their clients more effectively and conveniently. For example they will enjoy possibility of higher transaction limit, accessing analytical and statistical reporting, performing bulk transactions, establishing credit to be used in the solution. On the other hand they might be charged a fee (transactional basis or via subscription) unlike Users 110. Business Customers 112 can develop their own User Interface and call Business Services 104 through secure channel (VPN, IPSEC, and Private Line) to perform specific transactions.
(114) Customers 114 are Users who have successfully registered into the solution and their identity has been verified and confirmed through variety of standard methods. They have access to the features and services provided by the solution.
(119) Private Users: These users access the solution through Virtual Private Network 120. The VPN provides a secure line of communication to Private Users 119 to access Admin Application 178 hosted in secure zone.
(116) Help Desk 116 is an employee working in the back-office and supporting the Users 110, Business Customers 112 and Customers 114. They have limited privileges.
(118) Back Office Administrator (BOA) 118 is an employee working in the back-office with highest privileges to the solution. This user has authority to assist in manual transaction fulfillment if required.
   To serve the above actors and make the functionalities available, the solution implements a “Display Application” 101 for different channels. They are:
(106) Web Application: The solution provides a web application 106 as the main channel to provide access from internet. Via this web application 106 public users 115 can browse, register and utilize all possible functionalities. This web application 106 is secured through SSL protocol and other standard means to prevent hacking and cyber-attacks.
(108) Mobile Application: The solution provides a Mobile client application 108 as the secondary channel for public users 115 on internet. The Mobile Application 108 will be implemented to support major mobile operating systems (Android, iOS and BlackBerry).
   To serve the public users 115 who would like to implement their own customized “Third Party Display Application” 103 and access the solution's services, the solution provides “Business Services” 104 for different channels.
(104) Business Services: The solution provides Business Services 104 definitions through industry standard WebServices Description Language (WSDL) and Schemas to enable accessing the functionalities via their own “Third Party Display Application” 103. The functionalities exposed by Business Services 104 are a subset of available functions in the solution.
   Two examples for “Third Part Display Application” 103 are:
(107) Web Application: Third party uses their Web Application 107 to access the solution's Business Services 104 and leverage the exposed functionalities over SSL and web services security.
(109) Mobile Application: Third party uses their Mobile Application 109 to access the solution's Business Services 104 and leverage the exposed functionalities over SSL and web services security.
   The solution has a number of components in the back-end. They are organized in multiple layers under different security protocols to maintain the highest user safety. The first layer where the solution is implemented is the standard Demilitarized Zone 129. It comprised of the following modules:
(130) User Interface (Portal): The technology used to create the User Interface (Portal) 130 is series of ASPX pages built with Microsoft .NET framework 4.5 on IIS 7.0 running in Windows 2008 R2. The User Interface (Portal) 130 has public and private sections and uses the standard Forms Authentication method to authenticate Public Users 115 into the private sections. URL rewrite function is implemented in IIS.
(134) WebServices: The Business Services 104 are implemented here. Preferably it uses Microsoft Windows Communication Foundation (or an equivalent) to generate secure WebServices interface and expose them to be accessed by “Third Party Display Application” 103.
   The next layer in the solution, is the standard Application Layer 160 where the core components are implemented. The Façade Services 162 is the gateway that enables the User Interface (Portal) 130 and WebServices 134 access to Business Services 168.
   Application Layer's 160 core components are comprised of the following modules:
(162) Façade Services: The Façade Services 162 is the gateway that enables the User Interface (Portal) 130 and WebServices 134 access to Business Services 168. It is preferably implemented using Microsoft .NET Framework 4.5 running on IIS 7. SSL is used as the communication protocol and WS-Security is utilized.
(166) Batch Processes: Batch Processes 166 represents a series of Microsoft .NET 4.5 Console Applications which are executed on a predefined schedule. They perform tasks like End of Day reconciliation processing, Generating Reports through Reporting Services 176, archiving information in the Database 184 and purging data as per regulations prescribed in each country where the solution is implemented. These Batch Processes 166 also are capable of accessing multiple Queues (via MQ Manager 172) to extract and process messages. (i.e. Text Messages will be processed and sent out through the Application Gateway 174 to the “Text Message Service Provider” 158)
(168) Business Services: Business Services 168 contains the solution's Business Logic. It is preferably a .NET framework library of reusable business classes. This component is the only path to reach the Data Layer 184 via Data Services 170. It validates the incoming requests, formats the outgoing response, maintains the data integrity, handles exceptions and errors, generates logs and audit information, generates alerts for the Private Users 119 (Help Desk 116 and the Back Office Administrator 118).
(170) Data Services: Data Services 170 contains classes to manage Data Layer 184 connections and CRUD (Create/Read/Update/Delete) services. This isolates all data sources from the Application Layer 160 and prevents any unauthorized access to the Data Layer 184.
(172) MQ Manager: MQ Manager 172 preferably uses Microsoft MQ which is a standard Queue Manager provided by Microsoft. It manages multiple queues for requests and responses in Asynchronous method.
(174) Application Gateway: Application Gateway 174 is a secured Gateway to isolate and decouple communication between Application Layer 160 and External Systems/Vendors 140. It supports multiple standard protocols (HTTP, Soap, MQ, etc), authentication and authorization through SSL.
(176) Reporting Services: Reporting Services 176 are built preferably using SQL Reporting Services 2012 on Microsoft Windows 2008 R2 64 bits. They host all reports including statistical and analytical, compliance, audit and historical data from Data Layer 184. Reporting Services 176 provides the results in multiple standard formats (PDF, Excel, etc.)
(178) Admin Application: Admin Application 178 exposes administrative functions to Private Users 119 through Virtual Private Network 120. The technology used to create the Admin Application 178 is a standard web application using Microsoft .NET framework 4.5 on IIS 7.0 running in Windows 2008 R2. The site is deployed into the secure zone (Backbone). It is fully protected and uses two factor Authentication method to authenticate Private Users 119.
   The next layer in the solution, is the standard Data Layer 184 where the solution's information is stored. This information includes but not limited to Customer Information, Listings, Offers, Bids, Transactions (completed or in progress), Audit records, logging and so on. To provide high availability and failover, this layer is implemented in a standard clustered environment as follows:
(180) Database (Clustered): The Database 180 preferably uses Microsoft SQL 2012 technology in a clustered configuration for redundancy and high availability. The Database 180 provides tables for data storage, relational information for data integrity and indexing for search and data retrieval. Stored Procedures and Triggers are also implemented to support business needs.
(181) Database (Replication): The Database 181 preferably uses Microsoft SQL 2012 technology in a clustered configuration for redundancy and high availability. It is usually in passive mode and being populated through log-shipping or mirroring technology.
   In case of a disaster scenario when the main Database 180 has been lost, this Database 181 will take over through a configuration change. The characteristics of this Database 181 is identical to the Clustered Database 180.
(192) Operational Databases: Operational Databases 192 are a series of relational databases. They contain the User information, Account Information, latest Listings, Transactions and a variety of other information required for the system to operate.
(193) Audit & Trace Databases: Audit & Trace Databases are a series of relational databases. They contain the audit information, User activities with timestamp, detailed information for each financial transaction, system configuration changes made by Back Office Administrators 118, list of all communications with External Systems/Vendors 140 and other information in the same category.
(194) Enterprise Data Warehouse: Enterprise Data Warehouse 194 is a series of standard datamarts. They contain a subset of the operational data with specific retention periods to maintain the information for analytical and future data mining operations.
(197) Operational Databases: See 192
(198) Audit & Trace Databases: See 193
(199) Enterprise Data Warehouse: See 194
   The solution requires a local trust bank account in every country where it operates. This local bank account is where the local money is stored in trust on local user's behalf. Subsequently as the transaction fulfills, the control over the local funds are exchanged between transferors. The local Banks or Financial Institutions are considered an External Systems/Vendors 140 which will interface with the solution through Application Gateway 174. This connection will enable the solution to either provide services to External Systems/Vendors 140 or to consume services provided by them. These communications are all done through Internet over SSL/Private Line 100.
(100) Internet Over SSL/Private Line: For security reasons communication to selected External Systems/Vendors 140 are established through Internet Over SSL/Private Lines. The secured lines (IPSEC) are dedicated communication lines which guarantee the privacy and confidentiality between institutions.
(150) Local Bank/Third Party Financial Institution: For each country where the solution is implemented at least one local bank account (referred to as “trust account”) is required. This bank has to be able to provide online banking services and also offer electronic funds transfer functionality for business clients.
(152) Local Bank's Online Banking: Standard online banking facility to provide access to a business account to Back Office Administrator 118.
(154) Bank—Business Account: Business Account (Trust Account) is the physical account which is used by the solution to be able to operate in a country. This account will be used to temporarily hold local funds in trust which are being exchanged between transferors.
(156) Bank—Email Money Transfer WebService: One of the required methods of fund transfer is Email Money Transfer. This standard feature if offered by the Local Bank/Third Party Financial Institution 150 used by the solution and is one of the means to fulfill the transactions. The Email Money Transfer is used only between local user account and local trust account.
(158) Third Party Text Message Service Provider: A Third Party Text Message Service Provider 158 is used to deliver the text messages issued from the solution to the Public Users 115 registered mobile/cellphone.

The present invention has advantages over the previous system for engaging in monetary exchanges. Firstly, the system does not require actual funds to be exchanged over borders—no international monetary transactions actually occur. This has the advantage of reducing risk and potentially reducing banking fees. Furthermore, the system provides a method by which potential parties to a monetary exchange can bid on-line, providing customers (i.e. potential money exchange parties) convenience and potentially lower transaction costs.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims

Therefore, what is claimed is:

1. A system for facilitating a money transaction (transfer) in different currencies between first and second transferors, respectively, the system comprising:
a. A web portal coupled to a database, the database containing a record for each transferor recording:
i. identification information;
ii. a target amount and a target currency for a desired money transaction;
iii. a paying currency and a desired currency exchange rate for paying for the desired money transaction;
b. The web portal having a display application configured to permit the first and second transferors to post details of the transferor's target amount, target currency, paying currency and desired currency exchange rate;
c. The display application being further configured to enable each transferor to view details of the target amount, target currency, paying currency and desired exchange rate posted by the other transferor;
d. The web portal having a communication application configured to permit the first and second transferors to communicate with each other through the web portal and negotiate an agreed currency exchange rate for carrying out their respective desired money transfers;
e. A first money account and a second money account, the first and second money accounts being in different currencies, the first and second money accounts being coupled to a fulfillment application, the fulfillment application recording a first deposit of first funds into the first account by the first transferor, the fulfillment application recording a second deposit into the second account by the second transferor;
f. the fulfillment application recording a first and second control codes, the first control code controlling the first funds in the first account and the second control code controlling the second funds in the second account;
g. the fulfillment application being further configured to simultaneously transfer the first control code to the second transferor and the second control code to the first transferor upon the first and second transferors each signaling to the fulfillment application that a transfer agreement has been reached between them on the exchange rate.

2. A system for facilitating a money transaction (transfer) in different currencies between first and second transferors, respectively, the system comprising:
a. A web portal coupled to a database, the database containing a record for each transferor recording:
i. identification information;
ii. a target amount and a target currency for a desired money transaction;
iii. a paying currency and a desired currency exchange rate for paying for the desired money transaction;
b. The web portal having a display application configured to permit the first and second transferors to post details of the transferor's target amount, target currency, paying currency and desired currency exchange rate;
c. The display application being further configured to enable each transferor to view details of the target amount, target currency, paying currency and desired exchange rate posted by the other transferor;
d. The web portal having a communication application configured to permit the first and second transferors to communicate with each other through the web portal and negotiate an agreed currency exchange rate for carrying out their respective desired money transfers;
e. A first money account and a second money account, the first and second money accounts being in different currencies, the first and second money accounts being coupled to a fulfillment application, the fulfillment application recording a first deposit of first funds into the first account by the first transferor, the fulfillment application recording a second deposit into the second account by the second transferor;
f. the fulfillment application recording control of the first and second funds;
g. the fulfillment application being further configured to simultaneously transfer control of the first and second funds between the first and second transferors upon the first and second transferors each signaling to the fulfillment application that a transfer agreement has been reached between them on the exchange rate.

3. A system for facilitating a money transaction in different currencies between first and second parties, respectively, the system comprising:
a. A communication portal coupled to a database, the database containing a first record for the first party, the first record containing identification information for the first party and a first currency which the first party wishes to trade;
b. the database containing a second record for the second party, the second record containing identification information for the second party, and a second currency with which the second party wishes to trade a quantity of the first currency;
c. a display application coupled to the communication portal, the display application configured to allow the first party to post the first currency which the first party wishes to trade;
d. the communication portal configured to permit the first and second parties to communicate with each other and negotiate a trade of a specified amount of the first currency to the second party using the second currency at an agreed to exchange rate;
e. a first account in the first currency and a second account in the second currency, the first and second accounts being coupled to a fulfillment application, the fulfillment application recording a first deposit of first funds into the first account by the first party, the fulfillment application recording a second deposit into the second account by the second party;
f. the fulfillment application recording control of the first and second funds;
g. the fulfillment application being further configured to simultaneously transfer control of the first and second funds between the first and second parties without transferring the funds between the first and second accounts upon the first and second parties each signaling to the fulfillment application that the agreed to exchange rate was reached.

4. A system for facilitating an exchange of first and second currencies between a plurality of parties, the system comprising:
a. A communication portal coupled to a database, the database containing a record for each party, the record containing identification information for the party and currency information for the currency which said party wishes to trade;
b. a display application coupled to the communication portal, the display application configured to allow the parties to post information concerning one of the first and second currencies which said parties wishes to exchange;
c. the communication portal configured to permit the parties to communicate with each other and negotiate the exchange of the first currency for the second currency;
d. a first monetary account in the first currency and a second monetary account in the second currency, the first and second monetary accounts being coupled to a fulfillment application, the fulfillment application recording each deposit of first funds into the first monetary account and each deposit of second funds into the second monetary account;
e. the fulfillment application further recording which party controls the funds corresponding to each deposit of the first and second funds in the first and second monetary accounts;
f. the fulfillment application being further configured to simultaneously transfer control of the funds between the parties without actually transferring the funds upon the parties signaling the communications portal to transfer control.

5. The system of claim 4 wherein the first monetary account is in a first country and the second monetary account is in a second country.

6. The system of claim 2 wherein the first monetary account is in a first country and the second monetary account is in a second country.

7. A system for facilitating a money transfer in different currencies between first and second transferors, respectively, the system comprising:
a. A web portal coupled to a database, the database containing a record for each transferor recording:
i. identification information;
ii. a target amount and a target currency for a desired money transaction;
iii. a paying currency and a desired currency exchange rate for paying for the desired money transaction;
b. The web portal having a display application configured to permit the first and second transferors to post details of the transferor's target amount, target currency, paying currency and desired currency exchange rate;
c. The display application being further configured to enable each transferor to view details of the target amount, target currency, paying currency and desired exchange rate posted by the other transferor;
d. The web portal having a communication application configured to permit the first and second transferors to communicate with each other through the web portal and negotiate an agreed currency exchange rate for carrying out their respective desired money transfers;
e. A first money account and a second money account, the first and second money accounts being in different countries, the first and second money accounts being coupled to a fulfillment application, the fulfillment application recording a first deposit of first funds into the first account by the first transferor, the fulfillment application recording a second deposit into the second account by the second transferor;
f. the fulfillment application recording control of the first and second funds;
g. the fulfillment application being further configured to simultaneously transfer control of the first and second funds between the first and second transferors upon the first and second transferors each signaling to the fulfillment application that a transfer agreement has been reached between them on the exchange rate.

8. The system of claim 6 wherein the first and second money accounts are in separate first and second currencies, respectively.

9. The system of claim 3 wherein the first and second money accounts are in separate first and second countries, respectively.
